(19) United States
(12) Patent Application Publication
(10) Pub. No.: US 2024/0070833 A1
(43) Pub. Date: Feb. 29, 2024

(54) DETERMINATION SYSTEM

(71) Applicant: VALQUA, LTD., Tokyo (JP)

(72) Inventor: Yasushi Aburatani, Gojo-shi (JP)

(21) Appl. No.: 18/269,372

(22) PCT Filed: Feb. 16, 2022
(86) PCT No.: PCT/JP2022/006129

§ 371 Date: Jun. 23, 2023

(30) Foreign Application Priority Data
Mar. 29, 2021 (JP) 2021-055691

(51) Int. Cl. G06T 7/00; G06T 7/90

(52) U.S. Cl. CPC G06T 7/0002; G06T 7/90; G06T 2207/20224

(57) ABSTRACT

A system includes: an acquisition unit that acquires an image of a sealing surface of a flange; a calculation unit that calculates a first color difference between a color value of a first image of a first sealing surface to which rust is adhered and a color value of the image and a second color difference between a color value of a second image of a second sealing surface on which an adhesive material does not exist and a color value of the image; a coincidence calculation unit that calculates first coincidence between the first sealing surface and the sealing surface based on the first color difference, and calculates second coincidence between the second sealing surface and the sealing surface based on the second color difference; and a determination unit that determines a state of the adhesive material on the sealing surface based on the first and second coincidence.

### CROSS-REFERENCE TO RELATED APPLICATIONS

This application is a U.S. National Stage Application under 35 U.S.C. § 371 of International Application No. PCT/JP2022/006129, filed Feb. 16, 2022, titled DETERMINATION SYSTEM, which claims priority to Japanese Application No. 2021-055691, filed Mar. 29, 2021. International Application No. PCT/JP2022/006129 is incorporated by reference herein in its entirety.

### TECHNICAL FIELD

The present disclosure relates to a determination system.

### BACKGROUND ART

Conventionally, there is a gas leak detection system that finds a location of a high-temperature leak caused in a flange portion of a pipe carrying a fluid. For example, Japanese Patent Laying-Open No. 2009-192470 (PTL 1) discloses a technique capable of remotely detecting a gas leak from a flange of a pipe even when a leakage amount is small using an infrared camera.

### CITATION LIST

### Patent Literature

PTL 1: Japanese Patent Laying-Open No. 2009-192470

### SUMMARY OF INVENTION

### Technical Problem

One of the causes of the gas leakage from the flange portion is degradation or damage of a gasket used for a joint of pipes, so that a worker periodically replaces the gasket. At this point, the worker visually checks a state of the sealing surface of the flange, performs an appropriate operation such as cleaning or polishing on the sealing surface of the flange according to the state, and then replaces the sealing surface with the new gasket. However, technical knowledge and experience are required in order to check the state of the sealing surface of the flange and perform the appropriate operation corresponding thereto. Consequently, even when a person who is not an expert and lacks the knowledge and experience checks the sealing surface, it is often impossible to immediately determine what kind of work should be performed. Accordingly, there is a need for a system that can easily determine the state of the sealing surface of the flange without depending on the personal knowledge and experience.

An object of one aspect of the present disclosure is to provide a determination system capable of easily determining the state of the sealing surface of the flange.

### Solution to Problem

A determination system according to an embodiment includes: an image acquisition unit that acquires an image of a sealing surface of a target flange; a color difference calculation unit that calculates a first color difference between a color value of a first image of a first sealing surface to which rust is adhered and a color value of the image of the sealing surface of the target flange and a second color difference between a color value of a second image of a second sealing surface on which an adhesive material does not exist and a color value of the image of the sealing surface of the target flange; a coincidence calculation unit that calculates first coincidence between the first sealing surface and the sealing surface of the target flange based on the first color difference, and calculates second coincidence between the second sealing surface and the sealing surface of the target flange based on the second color difference; and a first determination unit that determines an adhesion state of the adhesive material on the sealing surface of the target flange based on the first coincidence and the second coincidence.

Preferably, the first determination unit determines that rust adheres to the sealing surface of the target flange regardless of the second coincidence when the first coincidence is greater than or equal to a first threshold.

Preferably, the first determination unit determines that the adhesive material does not exist on the sealing surface of the target flange when the first coincidence is less than a second threshold smaller than the first threshold and the second coincidence is greater than or equal to a third threshold.

Preferably, the first determination unit determines that the adhesive material other than the rust adheres to the sealing surface of the target flange when the first coincidence is less than the second threshold and the second coincidence is less than the third threshold.

Preferably, the determination system further includes a detection unit that detects a flaw generated on the sealing surface of the target flange based on the image of the sealing surface; a region determination unit that determines whether the flaw is included in a first region close to a center of the sealing surface of the target flange or a second region far from the center; and a second determination unit that determines whether to permit the flaw based on at least one of a thickness, a length, and an angle of the flaw and a region where the flaw exists.

Preferably, the second determination unit determines not to permit the flaw when the flaw exists in the first region and the thickness of the flaw is greater than or equal to a reference value, or when the flaw exists in the first region and an angle of the flaw is greater than or equal to a predetermined angle.

Preferably, the second determination unit determines not to permit the flaw when the flaw exists in the second region, the thickness of the flaw is greater than or equal to the reference value, and the angle of the flaw is greater than or equal to the predetermined angle.

Preferably, the second determination unit determines to permit the flaw when the flaw exists in the second region, the thickness of the flaw is less than the reference value, the angle of the flaw is less than the predetermined angle, and the length of the flaw is less than a predetermined length.

Preferably, the determination system further includes an output control unit that outputs advice information regarding the target flange based on at least one of a determination result of the first determination unit and a determination result of the second determination unit.

Preferably, the output control unit outputs advice information recommending polishing of the sealing surface of the target flange based on the determination result of the first determination unit that rust is adhered to the sealing surface of the target flange or the determination result of the second determination unit that the detected flaw is not permitted.

### Advantageous Effects of Invention

According to the present disclosure, the state of the sealing surface of the flange can be easily determined.

### BRIEF DESCRIPTION OF THE DRAWINGS

FIG. 1 is a view illustrating an overall configuration of a determination system.

FIG. 2 is a flowchart illustrating an example of an operation outline of the determination system.

FIG. 3 is a block diagram illustrating an example of a hardware configuration of an information processing device.

FIG. 4 is a view illustrating an analysis region of a sealing surface of a flange.

FIG. 5 is a view illustrating details of the analysis region in FIG. 4.

FIG. 6 is a view illustrating a determination criterion of an adhesion state.

FIG. 7 is a view illustrating a determination result of the adhesion state of each flange according to the determination criterion in FIG. 6.

FIG. 8 is a view illustrating a method for determining the adhesion state and advice information.

FIG. 9 is a view illustrating details of the analysis region used for determining a flaw state on a sealing surface.

FIG. 10 is a view illustrating a method for detecting the flaw generated on the sealing surface.

FIG. 11 is a view illustrating a method for determining the flaw state on the sealing surface.

FIG. 12 is a view illustrating a display example of a result report.

FIG. 13 is a block diagram illustrating an example of a functional configuration of the information processing device.

### DESCRIPTION OF EMBODIMENTS

With reference to the drawings, an embodiment according to the present disclosure will be described below. In the following description, the same component is denoted by the same reference numeral. Names and functions of such components are also the same. Therefore, no redundant detailed description will be given of such components.

<System Configuration>

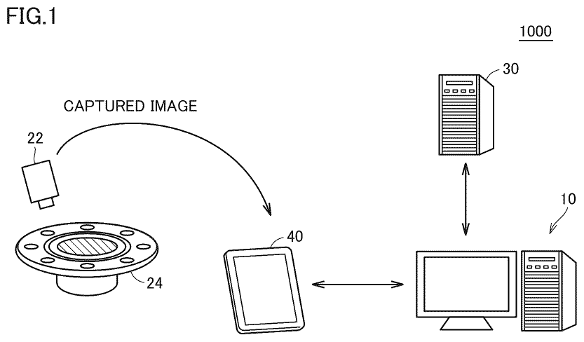

FIG. 1 is a view illustrating an overall configuration of a determination system 1000. With reference to FIG. 1, determination system 1000 is a system that determines a state of a sealing surface of a flange 24. Determination system 1000 includes an information processing device 10, a camera 22, a server 30, and a terminal device 40. In the embodiment, assumption that a scene in which information processing device 10 determines the state of the sealing surface of flange 24 when a worker who is a user of terminal device 40 replaces a used sealing material used for fastening flange 24 with a new pre-use sealing material is given. Hereinafter, the sealing surface of flange 24 of a determination target is sometimes referred to as a “target sealing surface”.

A sealing material conforming to a standard of flange 24 is used as the sealing material. In order to appropriately fasten a pair of flanges 24 through the sealing material, the worker captures an image of the target sealing surface using camera 22 and takes the captured image into terminal device 40. Terminal device 40 transmits the captured image to information processing device 10. Information processing device 10 analyses the received captured image to determine the state of the target sealing surface, and transmits advice information based on the determination result to terminal device 40.

Seal material is sandwiched between the pair of flanges 24 and fixed as a result of fastening flanges 24 with a bolt so as to prevent a fluid from leaking from a gap between flanges 24. For example, the sealing material is a fixing sealing material called a gasket. The gasket is a seal material capable of sealing a gap in a portion where the gasket is installed to make the portion airtight. There are various types of gaskets, and the gasket is appropriately selected in accordance with how a pipe is used. The sealing material may be a dynamic sealing material called packing.

Terminal device 40 is capable of communicating with information processing device 10. Terminal device 40 acquires the captured image of flange 24 and transmits the captured image to information processing device 10. Terminal device 40 receives the advice information regarding the state of the target sealing surface from information processing device 10 as a response to the captured image. Terminal device 40 is typically, but is not limited to, a smartphone, and may be, for example, a tablet terminal device. Terminal device 40 may be capable of communicating with sever 30.

Terminal device 40 acquires the captured image of sealing surface of flange 24 from camera 22. As an example, camera 22 includes an imaging element partitioned into a plurality of pixels, such as a coupled charged device (CCD) or a complementary metal oxide semiconductor (CMOS) sensor, in addition to an optical system such as a lens. The taken image taken by camera 22 is transmitted to terminal device 40.

In the embodiment, information processing device 10 determines the state of the target sealing surface based on the captured image of flange 24 of the determination target and the captured images of the flanges in various states stored in a database.

Information processing device 10 typically has a structure based on a general-purpose computer architecture, and causes a processor to execute a previously-installed program to perform various pieces of processing described later. For example, information processing device 10 is a desktop personal computer (PC). However, information processing device 10 only needs to be a device capable of performing functions and processing to be described below, and may be a different device (such as a laptop PC or a tablet terminal device).

Server 30 is capable of communicating with information processing device 10. Server 30 receives various processing results by information processing device 10, and stores the various processing results in the database.

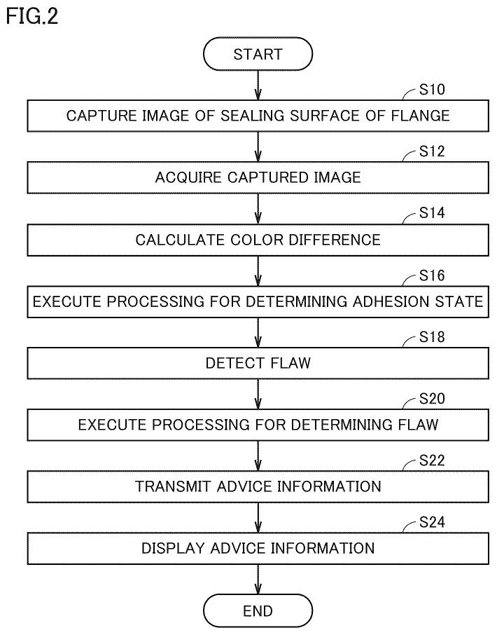

FIG. 2 is a flowchart illustrating an example of an operation outline of the determination system. With reference to FIG. 2, camera 22 captures the image of the sealing surface of flange 24 to generate the captured image (step S10). Information processing device 10 acquires the captured image from camera 22 and stores the captured image in an internal memory (step S12). Information processing device 10 also stores imaging conditions (for example, imaging distance, resolution, light irradiation angle, light source wavelength, and luminance) when image of flange 24 is captured.

Information processing device 10 calculates a color difference between a color value of the image of the sealing surface of flange 24 and a color values of the images of the plurality of reference sealing surfaces (step S14). For example, when the color values of the images of the target sealing surface are L₁*, a₁*, b₁* and the color values of the images of the reference sealing surface are L₂*, a₂*, b₂*, color difference ΔE is expressed by ΔE={(L₂*−L₁*)²+(a₂*−a₁*)²+(b₂*−b₁*)²}^{1/2}. For example, the color values of the plurality of reference sealing surfaces include a color value of the sealing surface to which rust is adhered and a color value of the sealing surface in a good state in which no adhesive material exists. The color value (or the image itself) of the image of each reference sealing surface is stored in the memory of information processing device 10.

Information processing device 10 executes determination processing using the plurality of calculated color differences ΔE and executes processing for determining the adhesion state of the adhesive material on the target sealing surface (step S16). Although details will be described later, information processing device 10 calculates coincidence between each reference sealing surface and the target sealing surface using each color difference ΔE, and determines the adhesion state of the target sealing surface based on each coincidence. Information processing device 10 analyzes a binarized image obtained by binarizing the captured image, and detects a flaw generated on the target sealing surface (step S18). Information processing device 10 executes processing for determining the state of the detected flaw (step S20). Although details will be described later, information processing device 10 determines whether to permit the flaw (that is, whether the flaw is a flaw within a permissible range) based on the position, thickness, angle, length, and the like of the detected flaw.

Information processing device 10 produces advice information based on each determination result executed in steps S16 and S20 and transmits each determination result and the advice information to terminal device 40 (step S22). Terminal device 40 displays received each determination result and the advice information on a display (step S24). Information processing device 10 may transmit each determination result and the advice information to server 30. In this case, server 30 stores the determination result and advice information received from information processing device 10 in a database.

According to determination system 1000, the adhesion state of the adhesive material and the state of the flaw on the sealing surface are determined using the captured image of the sealing surface of flange 24, and the advice information corresponding to the states is provided. Consequently, even a person who is not an expert can quickly grasp the state of the sealing surface, and a treatment suitable for the state of the sealing surface can be efficiently performed.

<Hardware Configuration>

(Information Processing Device)

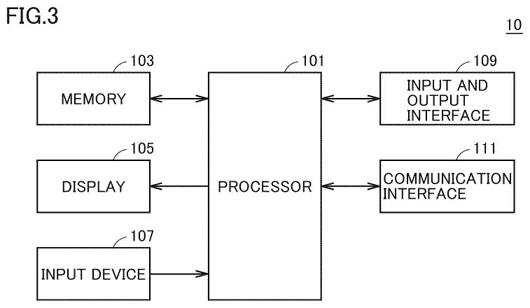

FIG. 3 is a block diagram illustrating an example of a hardware configuration of information processing device 10. With reference to FIG. 3, information processing device 10 includes a processor 101, a memory 103, a display 105, an input device 107, an input and output interface (I/F) 109, and a communication interface (I/F) 111. Such units are data-communicatively interconnected.

Processor 101 is typically an arithmetic processing unit such as a central processing unit (CPU) or a multi processing unit (MPU). Processor 101 reads and executes a program stored in memory 103 to control the operation of each unit of information processing device 10. More specifically, processor 101 executes the program to perform each function of information processing device 10.

Memory 103 is implemented by a random access memory (RAM), a read-only memory (ROM), a flash memory, a hard disk, or the like. Memory 103 stores the program executed by processor 101, the captured image acquired by camera 22, and the like.

Display 105 is, for example, a liquid crystal display, an organic electro luminescence (EL) display, or the like. Display 105 may be formed integrally with information processing device 10 or may be provided separately from information processing device 10.

Input device 107 receives an operation input directed to information processing device 10. Input device 107 is implemented by, for example, a keyboard, a button, a mouse, or the like. Further, input device 107 may be implemented as a touchscreen.

Input and output interface 109 is used for data transmission between processor 101 and camera 22. For example, input and output interface 109 is connected to camera 22. Processor 101 acquires the captured image captured by camera 22 through input and output interface 109.

Communication interface 111 is used for data transmission between processor 101 and server 30 and terminal device 40 and the like. As the communication system, for example, a radio communication system such as Bluetooth (registered trademark) or a wireless local area network (LAN) is used. Note that as the communication system, a wired communication system such as universal serial bus (USB) may be used.

Processor 101 may communicate with camera 22 through communication interface 111.

(Server)

Server 30 only needs to be able to provide information processing as described later as a whole, and a known hardware configuration may be applied to the hardware configuration of server 30. For example, server 30 includes a processor for executing various types of processing, a memory for storing a program, data, and the like, a communication interface for transmitting and receiving various types of data to and from information processing device 10, and an input device for receiving the instruction from the user.

(Terminal Device)

Terminal device 40 only needs to be able to provide information processing as described later as a whole, and a known hardware configuration may be applied to the hardware configuration of terminal device 40. For example, terminal device 40 includes a processor, a memory, a communication interface for transmitting and receiving various types of data to and from information processing device 10, the touchscreen receiving the instruction from the user, and a display for displaying various pieces of information.

<Method for Determining Adhesion State>

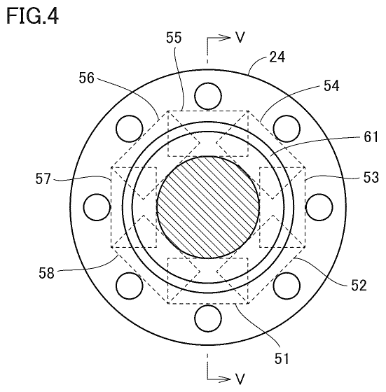

FIG. 4 is a view illustrating an analysis region of the sealing surface of flange 24. With reference to FIG. 4, analysis regions 51 to 58 of flange 24 are set as a region including a fastening unit 61 on the sealing surface of flange 24. Fastening unit 61 is a region where a sealing material (for example, a gasket) is disposed. Camera 22 captures the image of the sealing surface including analysis regions 51 to 58 of flange 24. Camera 22 may generate the captured image including all analysis regions 51 to 58, or generate a different captured image for each of analysis regions 51 to 58. Information processing device 10 executes the adhesion state determination processing for each of analysis regions 51 to 58. The adhesion state determination method in each analysis region is the same. Therefore, in the following, a method of determining the adhesion state in analysis region 51 will be described as a representative.

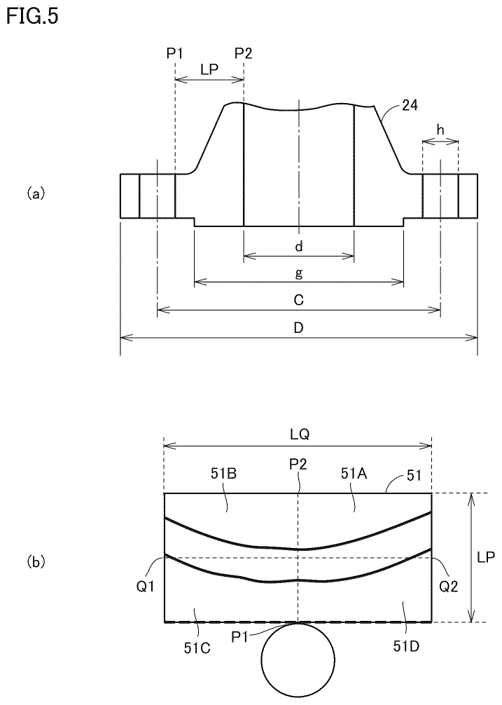

FIG. 5 is a view illustrating details of the analysis region in FIG. 4. Specifically, FIG. 5(a) is a schematic sectional view taken along a line V-V in FIG. 4. FIG. 5(b) is a view illustrating the image including analysis region 51 in FIG. 4.

With reference to FIG. 5(a), C is a center circle diameter of a bolt hole, D is an outer diameter, g is a seat diameter, d is an inner diameter, and h is a bolt hole diameter. The distance between ta point P1 and a point P2 of rectangular analysis region 51 in FIG. 5(b) is indicated by LP. In this case, LP=(C/2−d/2−h/2).

In addition, the distance between a point Q1 and a point Q2 of analysis region 51 in FIG. 5(b) is defined as LQ. As illustrated in FIG. 4, the number of bolts is eight, and LQ corresponds to the length of one side of the octagon. Consequently, LQ=2(C/2−h/2)×tan {(360°/(2×8)}. Analysis region 51 includes four regions 51A to 51D divided by a line segment connecting point P1 and point P2 and a line segment connecting point Q1 and point Q2.

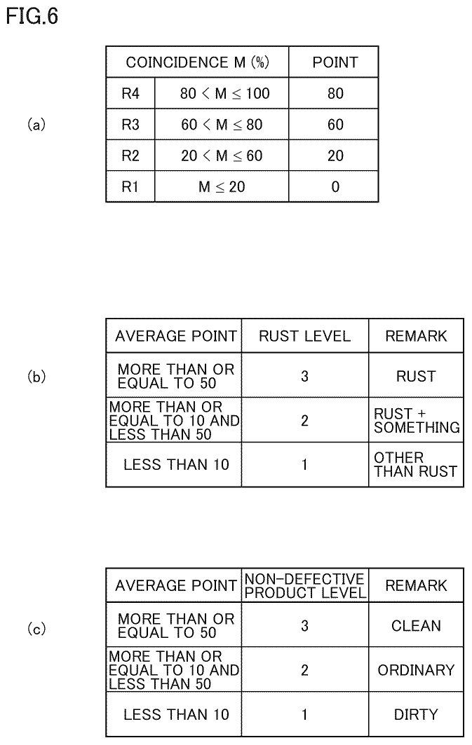

FIG. 6 is a view illustrating a determination criterion of the adhesion state. Specifically, FIG. 6(a) is a view illustrating a relationship between coincidence M of the color difference and the point. When 80<M≤100, the rank is R4 and the point is 80. When 60<M≤80, the rank is R3 and the point is 60. When 20<M≤60, the rank is R2 and the point is 20. When M≤20, the rank is R1 and the point is 0.

FIG. 6(b) is a view illustrating the relationship between the average point of coincidence M1 in each of regions 51A to 51D and a rust level indicating an adhesion degree of the rust. When the average point is greater than or equal to 50, the rust level is “3”. The rust level “3” indicates that the rust adheres to the sealing surface. When the average point is greater than or equal to 10 and less than 50, the rust level is “2”. The rust level “2” indicates the state in which the rust and the adhesive material other than the rust adhere to the sealing surface. When the average point is less than 10, the rust level is “1”. The rust level “1” indicates that the adhesive material other than the rust adheres to the sealing surface or that no adhesive material exists. The average point of coincidence M1 in each of regions 51A to 51D corresponds to coincidence M1 in analysis region 51.

FIG. 6(c) is a view illustrating the relationship between the average point of coincidence M2 in each of regions 51A to 51D and a non-defective product level indicating how good the state is. When the average point is greater than or equal to 50, the non-defective product level is “3”. The non-defective product level “3” indicates a clean state in which almost no adhesive material exists on the sealing surface. When the average point is greater than or equal to 10 and less than 50, the non-defective product level is “2”. The non-defective product level “2” indicates an ordinary state in which the adhesive material slightly exists on the sealing surface. When the average point is less than 10, the non-defective product level is “1”. The non-defective product level “1” indicates a state in which the adhesive material exists on the sealing surface and that the sealing surface is contaminated. The average point of coincidence M2 in each of regions 51A to 51D corresponds to coincidence M2 in analysis region 51.

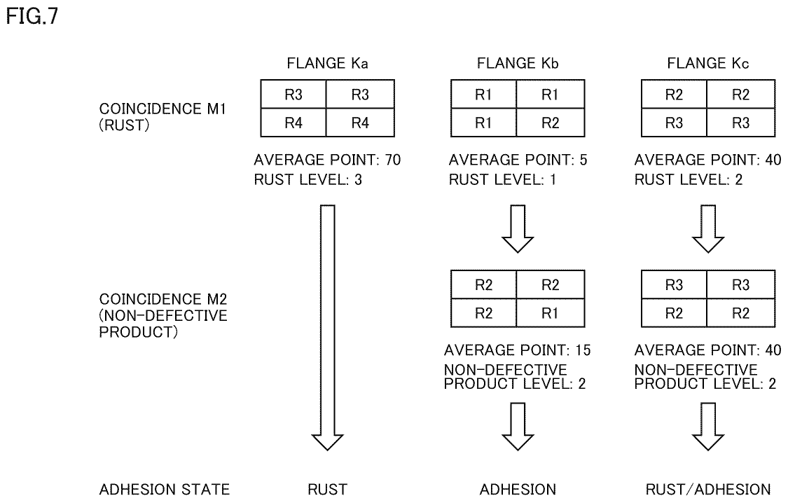

FIG. 7 is a view illustrating the adhesion state determination result of each flange according to the determination criterion in FIG. 6. It is assumed that information processing device 10 determines the states of the sealing surfaces of flanges Ka, Kb, Kc (hereinafter, also collectively referred to as a “flange K”). It is assumed that the color values of respective regions 51A to 51D of the sealing surface in a rust-adhered state and the color values of respective regions 51A to 51D of the sealing surface in which no adhesive material exists are stored in memory 103 of information processing device 10.

Information processing device 10 evaluates the rust level in each of regions 51A to 51D of flange K. Specifically, information processing device 10 calculates color difference ΔE1 between the color value of region 51A of the sealing surface of flange K and the color value of region 51A of the sealing surface to which the rust adheres. Information processing device 10 calculates coincidence M1 expressed as a percentage by converting color difference ΔE1 into a ratio. M1=(1/ΔE1). For example, when ΔE1=2.8, M1=(1/2.8)×100=35.7%. Coincidence M1 is similarly calculated for regions 51B to 51D.

With reference to FIGS. 6 and 7, in flange Ka, ranks of regions 51A, 51B, 51C, 51D are R3, R3, R4, R4, respectively. In addition, because the average value (that is, the average point) of the points in each of regions 51A to 51D is 70, the rust level is “3” (see FIG. 6(b)). Similarly, in flange Kb, because the average point is 5, the rust level is “1”. In flange Kc, because the average point is 40, the rust level is “2”.

Subsequently, information processing device 10 evaluates the non-defective product level of each of regions 51A to 51D of flange K. Specifically, information processing device 10 calculates a color difference ΔE2 between the color value of region 51A of the sealing surface of flange K and the color value of region 51A of the sealing surface where no adhesive material exists. Information processing device 10 calculates coincidence M2 expressed as a percentage by converting color difference ΔE2 into the ratio. M2=(1/ΔE2). Coincidence M2 is similarly calculated for regions 51B to 51D.

With reference to FIGS. 6 and 7, because the rust level of flange Ka is “3” and because it is determined that the rust is attached, the evaluation of the non-defective product level is omitted. The evaluation of the non-defective product level may also be performed for flange Ka. In flange Kb, ranks of regions 51A, 51B, 51C, 51D are R2, R2, R2, R1, respectively. Because the average value (that is, the average point) of the points in each of regions 51A to 51D is 15, the non-defective product level is “2” (see FIG. 6(c)). Similarly, because the average point of flange Kc is 40, the non-defective product level is “2”.

Thus, information processing device 10 determines that the rust adheres to the sealing surface of flange Ka, determines that some adhesive material other than the rust adheres to the sealing surface of flange Kb, and determines that the rust and the adhesive material other than the rust adhere to the sealing surface of flange Kc. For example, the other adhesive material is a part of the sealing material (gasket).

Subsequently, a method for determining the adhesion state based on the combination of the rust level and the non-defective product level and the advice information provided according to the adhesion state will be described more specifically.

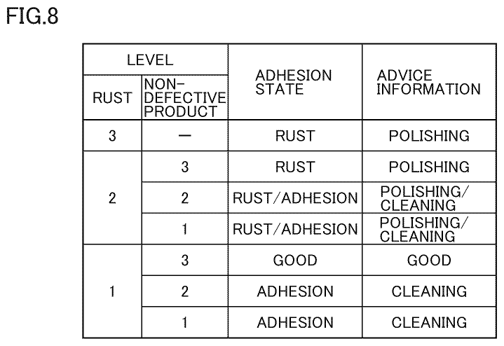

FIG. 8 is a view illustrating the method for determining the adhesion state and the advice information. With reference to FIG. 8, when the rust level is “1” or when the rust level is “2” and the non-defective product level is “3”, information processing device 10 determines that the rust adheres to the sealing surface (corresponding to “rust” in FIG. 8) and generates the advice information recommending polishing of the sealing surface.

When the rust level is “2” and the non-defective product level is “2” or “1”, information processing device 10 determines that the rust and other adhesive material adhere to the sealing surface (corresponding to “rust/attachment” in FIG. 8), and generates the advice information recommending polishing and cleaning of the sealing surface.

When the rust level is “1” and the non-defective product level is “3”, information processing device 10 determines that there is no adhesive material on the sealing surface and that the state is good (corresponding to “good” in FIG. 8), and generates the advice information indicating that the state is good. In this case, information processing device 10 generates information prompting the worker to determine the flaw state.

When the rust level is “1” and the non-defective product level is “2” or “1”, information processing device 10 determines that the adhesive material other than the rust adheres to the sealing surface (corresponding to “adhesion” in FIG. 8) and generates the advice information recommending cleaning of the sealing surface.

Typically, when checking the advice information recommending the work of polishing or cleaning of the sealing surface, the worker captures the image of the sealing surface again after completion of the work, and transmits the captured image to information processing device 10. Information processing device 10 determines the adhesion state again based on the captured image. In this case, when it is determined that the adhesion state is “rust” or “rust/adhesion”, information processing device 10 generates the advice information recommending re-polishing. When the adhesion state is determined to be “adhesion”, information processing device 10 generates the advice information recommending polishing.

When it is determined that the adhesion state is “rust” or “rust/adhesion”, information processing device 10 generates the advice information recommending the re-polishing. When the adhesion state is determined to be “adhesion”, information processing device 10 generates the advice information recommending polishing. As a result of the redetermination, when information processing device 10 determines that the adhesion state is the good state, information prompting the worker to determine the flaw state is generated.

In the above description of FIG. 6, analysis region 51 is divided into four regions 51A to 51D, but the analysis region may not be divided. Furthermore, the configuration in which information processing device 10 converts the coincidence for each of regions 51A to 51D into the point and determines the adhesion state based on the average value (that is, the average point) of the points has been described, but the coincidence may not be converted into points.

For example, when coincidence M1 in analysis region 51 is greater than or equal to a threshold Th1 (for example, 50%) (for example, rust level 3), information processing device 10 determines that the rust adheres to the sealing surface of flange 24 regardless of coincidence M2. Furthermore, when coincidence M1 is less than a threshold Th2 (for example, 10%) smaller than threshold Th1 (for example, rust level 1), and coincidence M2 is greater than or equal to a threshold Th3 (for example, 50%) (for example, non-defective product level 3), information processing device 10 may determine that no adhesive material exists on the sealing surface of flange 24 (that is, the good state). Furthermore, when coincidence M1 is less than threshold Th2 (for example, rust level 1) and coincidence M2 is less than threshold Th3 (for example, non-defective level 2 or 1), information processing device 10 determines that another adhesive material is attached to the sealing surface of flange 24.

<Method for Determining Flaw State>

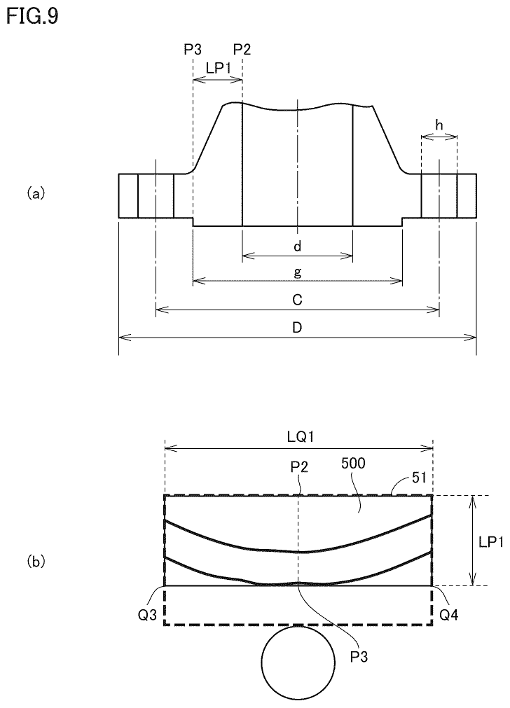

FIG. 9 is a view illustrating details of the analysis region used for determining the flaw state on the sealing surface. Specifically, FIG. 9(a) is a schematic sectional view taken along a line V-V in FIG. 4. FIG. 9(b) is a view illustrating the image including analysis region 51 in FIG. 4.

With reference to FIGS. 9(a) and 9(b), the analysis region used to determine the flaw state on the sealing surface is a rectangular region 500 included in analysis region 51. The distance between point P2 and a point P3, which is the length of rectangular region 500 in the longitudinal direction, is LP1. In this case, LP1=(g/2−d/2). A distance between a point Q3 and a point Q4, which is a length in the lateral direction of rectangular region 500 in FIG. 9(b), is defined as LQ1. LQ1 is the same as distance LQ in FIG. 5. Consequently, LQ1=2(C/2−h/2)×tan{(360°/(2×8)}.

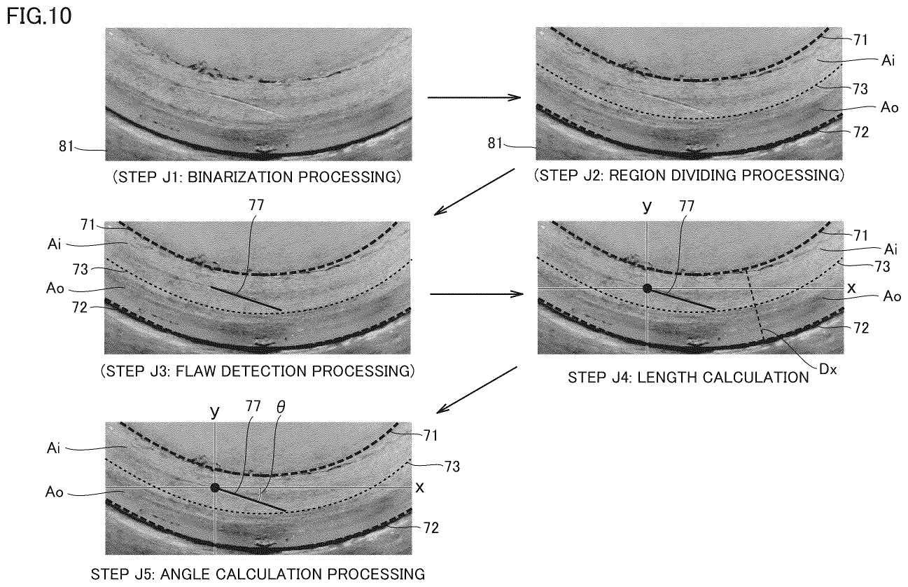

FIG. 10 is a view illustrating the method for detecting the flaw generated on the sealing surface. With reference to FIG. 10, in step J1, information processing device 10 generates an image 81 obtained by binarizing the region of rectangular region 500 in FIG. 9(b). In step J2, information processing device 10 detects a line 71 indicating the circumference inside fastening unit 61 in FIG. 4 and a line 72 indicating the circumference outside fastening unit 61 by the image processing. Information processing device 10 draws a line 73 that bisects a region surrounded by line 71 and line 72, and divides the region surrounded by line 71 and line 72 into a region Ai surrounded by line 71 and line 73 and a region Ao surrounded by line 72 and line 73.

In step J3, information processing device 10 detects the flaw generated in region Ai and region Ao, and draws a line segment 77 indicating the detected flaw. The flaw on the sealing surface may be detected using a known technique. For example, information processing device 10 detects the flaw on the sealing surface by comparing a feature amount of the flaw stored previously in memory 103 with a feature amounts of the images in regions Ai and region Ao. Furthermore, information processing device 10 calculates a thickness W of line segment 77.

In step J4, information processing device 10 calculates a length F of line segment 77. For example, information processing device 10 defines an xy-plane having one end of line segment 77 as an origin. At this time, when a coordinate of the other end of line segment 77 is (x1,y1), F=(x1²+y1²)^{1/2}. In step J5, information processing device 10 calculates an angle θ formed by line segment 77 and an x-axis. However, it is assumed that angle θ is an acute angle.

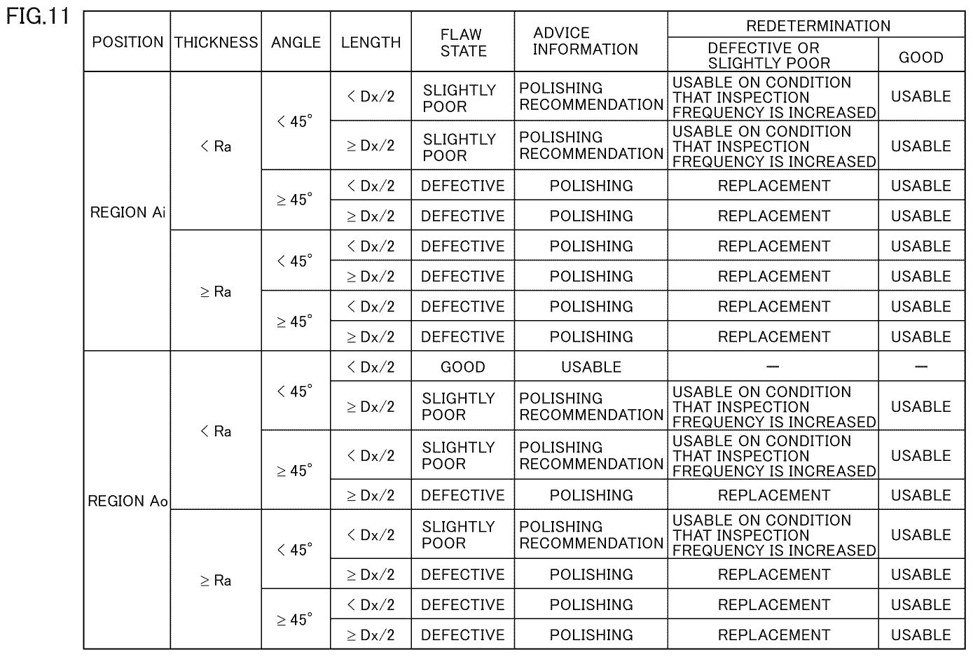

FIG. 11 is a view illustrating the method for determining the flaw state on the sealing surface. With reference to FIG. 11, information processing device 10 determines the flaw state based on the position of the detected flaw (line segment 77), thickness W of the flaw, length F of the flaw, and angle θ.

Specifically, information processing device 10 determines whether the detected flaw is region Ai or region Ao. When the flaw is included in both region Ai and region Ao, information processing device 10 determines that the flaw is included in region Ai. Region Ai is a region close to the center of the sealing surface, and region Ao is a region far from the center of the sealing surface. Accordingly, region Ai is inside region Ao and is close to a place where fluid (for example, gas) is transported. Accordingly, in consideration of fluid leakage, the flaw exists preferably in region Ao rather than region Ai.

Information processing device 10 determines whether thickness W of the flaw is greater than or equal to a reference value Ra. For example, reference value Ra is surface roughness during flange processing. This is based on the idea that when the thickness of the flaw is less than the surface roughness during the flange processing, the thickness of the flaw is generally permissible.

Information processing device 10 determines whether length F is greater than or equal to a predetermined length. For example, the predetermined length is ½ of a distance Dx (see FIG. 10) between inner line 71 and outer line 72 of fastening unit 61. Because the fluid leakage is more likely to be generated as length F of the flaw is longer, preferably length F is smaller in the flaw state.

Information processing device 10 determines whether angle θ is greater than or equal to a predetermined angle (for example, 45°). As angle θ of the flaw is larger, the fluid is more likely to leak from the inside to the outside. Accordingly, the smaller angle θ is, the more preferable the state of the flaw is.

Information processing device 10 determines the detected flaw state based on the above four determination results. First, the case where the flaw exists in region Ai will be described. When thickness W is greater than or equal to reference value Ra or angle θ is greater than or equal to 45°, information processing device 10 determines that the flaw state is defective. When thickness W is less than reference value Ra and the angle is less than 45°, information processing device 10 determines that the flaw state is slightly poor.

The case where the flaw exists in region Ao will be described below. In any of the case where thickness W is greater than or equal to reference value Ra and angle θ is greater than or equal to 45°, the case where thickness W is greater than or equal to reference value Ra and length F is greater than or equal to Dx/2, and the case where thickness W is less than reference value Ra, angle θ is greater than or equal to 45°, and length F is greater than or equal to Dx/2, information processing device 10 determines that the flaw state is defective. In any of the case where thickness W is greater than or equal to reference value Ra, angle θ is less than 45°, and length F is less than Dx/2, the case where thickness W is less than reference value Ra, angle θ is greater than or equal to 45°, and length F is less than Dx/2, and the case where thickness W is less than reference value Ra, angle θ is less than 45°, and length F is greater than or equal to Dx/2, information processing device 10 determines that the flaw state is slightly poor. In the case where thickness W is less than reference value Ra, angle θ is less than 45°, and length F is less than Dx/2, information processing device 10 determines that the flaw state is good.

When the state of the flaw is “bad” or “slightly bad”, information processing device 10 determines that the flaw is not permissible (that is, it is out of the permissible range). Accordingly, information processing device 10 generates the advice information strongly recommending polishing of the sealing surface when the state of the flaw is “poor”, and generates the advice information recommending polishing of the sealing surface when the flaw state is “slightly poor”. On the other hand, when the flaw state is “good”, information processing device 10 determines that the flaw is permissible (that is, it is within the permissible range). Accordingly, information processing device 10 generates the advice information indicating that the sealing face is in the usable state when the flaw state is “good”.

Typically, when the worker confirms the advice information recommending the polishing work on the sealing surface, the worker captures the image of the sealing surface again after completion of the work, and transmits the captured image to information processing device 10. Information processing device 10 determines the flaw state again based on the captured image. When the flaw state is determined to be “slightly defective” in the previous determination processing and the flaw state is determined to be “slightly defective” also in the current determination processing, information processing device 10 generates the advice information indicating that flange 24 is usable on condition that an inspection frequency is increased.

Information processing device 10 generates the advice information recommending replacement of flange 24 with another flange when the flaw state is determined to be “slightly poor” or “defective” in the previous determination processing and the flaw state is determined to be “defective” in the current determination processing. Information processing device 10 generates the advice information indicating that flange 24 is usable when the flaw state is determined to be “slightly poor” or “defective” in the previous determination processing and the flaw state is determined to be “good” in the current determination processing.

In the flaw detection method of FIG. 10, when no flaw on the sealing surface is detected in the first place, information processing device 10 determines that the flaw state is “good” and generates the advice information indicating that flange 24 is usable.

### Display Example

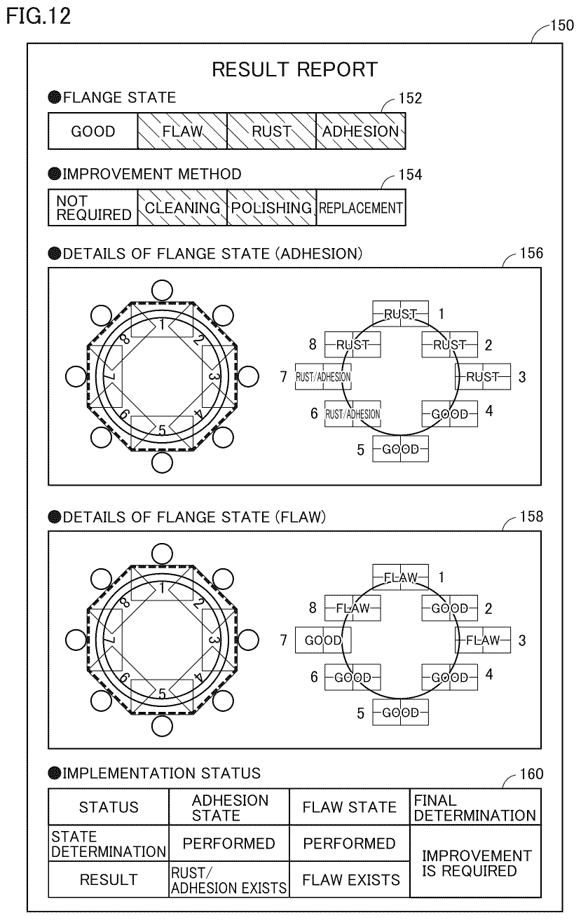

After the state determination processing of flange 24 as described above, information processing device 10 transmits the determination result and the advice information to terminal device 40. Terminal device 40 displays the result report as illustrated in FIG. 12 based on the determination result and the advice information. Information processing device 10 may individually or collectively transmit the determination result of the adhesion state of flange 24 and the determination result of the flaw state of flange 24.

FIG. 12 is a view illustrating a display example of a result report. With reference to FIG. 12, terminal device 40 displays a user interface screen 150 indicating the result report on the display, and user interface screen 150 includes display regions 152, 154, 156, 158, 160.

Display region 152 is a region displaying an outline of the state of flange 24. In the example of FIG. 12, it is illustrated that the flaw exists on the sealing surface of flange 24, and the rust and other adhesive materials adhere. Display region 154 is a region displaying an improvement method. The example in FIG. 12 illustrates that cleaning and polishing of the sealing surface of flange 24 are recommended as the improvement method.

Display area 156 is an area displaying details of the adhesion state of flange 24. In the example of FIG. 12, the state determination results (“rust”, “rust/adhesion” or “good”) are illustrated for each of the eight positions on the sealing surface. Display region 158 is a region displaying details of the flaw state of flange 24. In the example of FIG. 12, the state determination result (“flaw” or “good”) is illustrated for each of the eight locations on the sealing surface. The state determination result “flaw” corresponds to the determination result of “slightly defective” or “defective” in FIG. 11.

Display region 160 is a region displaying implementation status of the state determination of flange 24. In the example of FIG. 12, each determination of the adhesion state and the flaw state has been performed, the determination result of the adhesion state “rust/adhesion exists” is illustrated, and the determination result of the flaw state “flaw exists” is illustrated. It is indicated that improvement is required as the final determination result.

<Functional Configuration>

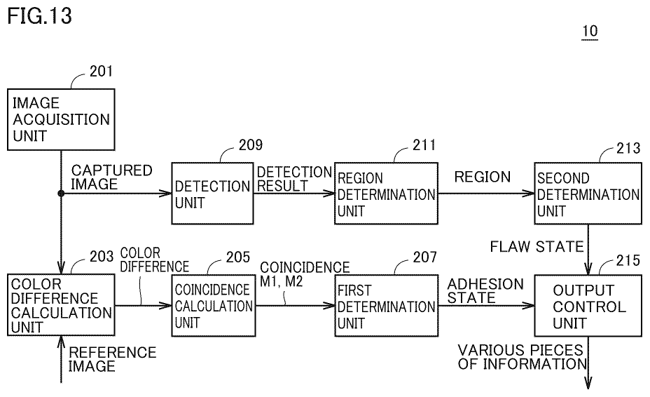

FIG. 13 is a block diagram illustrating an example of a functional configuration of information processing device 10. With reference to FIG. 13, information processing device 10 includes an image acquisition unit 201, a color difference calculation unit 203, a coincidence calculation unit 205, a first determination unit 207, a detection unit 209, a region determination unit 211, a second determination unit 213, and an output control unit 215 as a main functional configuration. For example, functions of such units are each implemented through the program executed by processor 101 of information processing device 10, the program being stored in memory 103. Note that some or all of the functions may be implemented via hardware.

Image acquisition unit 201 acquires the captured image of the sealing surface of flange 24 captured by camera 22 from camera 22.

Color difference calculation unit 203 calculates the color difference (for example, ΔE1) between the color value of the reference image of the first sealing surface to which the rust is adhered and the color value of the image of the sealing surface of flange 24. Color difference calculation unit 203 calculates the color difference (for example, ΔE2) between the color value of the reference image of the second sealing surface on which no adhesive material exists and the color value of the image of the sealing surface of flange 24. Memory 103 stores each color value of the reference image of the sealing surface to which the rust is adhered and the reference image of the sealing surface to which no adhesive material exists.

Coincidence calculation unit 205 calculates coincidence M1 between the first sealing surface and the sealing surface of flange 24 based on color difference ΔE1. Coincidence calculation unit 205 calculates coincidence M2 between the second sealing surface and the sealing surface of flange 24 based on color difference ΔE2.

First determination unit 207 determines the adhesion state of the adhesive material on the sealing surface of flange 24 based on coincidence M1 and coincidence M2. Specifically, when coincidence M1 is greater than or equal to threshold Th1 (for example, 50%), first determination unit 207 determines that the rust adheres to the sealing surface of flange 24 regardless of coincidence M2. When coincidence M1 is less than threshold Th2 (for example, 10%) and coincidence M2 is greater than or equal to threshold Th3 (for example, 50%), first determination unit 207 determines that no adhesive material exists on the sealing surface of flange 24. When coincidence M1 is less than threshold Th2 and coincidence M2 is less than threshold Th3, first determination unit 207 determines that the adhesive material (for example, a part of the sealing material) other than the rust adheres to the sealing surface of flange 24.

Detection unit 209 detects the flaw generated on the sealing surface based on the image of the sealing surface of flange 24. Detection unit 209 detects the flaw according to the detection method described in FIG. 10. Detection unit 209 calculates thickness W, length F, and angle θ of the flaw.

Region determination unit 211 determines whether the detected flaw is included in a first region (for example, region Ai) close to the center of the sealing surface of flange 24 or in a second region (for example, region Ao) far from the center.

Second determination unit 213 determines whether to permit the flaw based on at least one of thickness W, length F, and angle θ of the flaw and the region where the flaw exists. Specifically, when the flaw exists in region Ai and thickness W is greater than or equal to reference value Ra, or when the flaw exists in region Ai and angle θ is greater than or equal to a predetermined angle (for example, 45°), second determination unit 213 determines not to permit the flaw. When the flaw exists in region Ao, thickness W is greater than or equal to reference value Ra, and angle θ is greater than or equal to the predetermined angle, second determination unit 213 determines not to permit the flaw. On the other hand, when the flaw exists in region Ao, thickness W is less than reference value Ra, angle θ is less than the predetermined angle, and length F is less than the predetermined length, second determination unit 213 determines to permit the flaw.

Output control unit 215 outputs the advice information regarding flange 24 based on at least one of the determination result of first determination unit 207 and the determination result of second determination unit 213. For example, output control unit 215 outputs the advice information recommending polishing of the sealing surface of flange 24 based on the determination result of first determination unit 207 that the rust is adhered to the sealing surface of flange 24 or the determination result of second determination unit 213 that the detected flaw is not permitted.

<Advantages>

According to the embodiment, the adhesion state of the adhesive material and the flaw state on the sealing surface are determined using the captured image of the sealing surface of the flange, and the advice information corresponding to the states is provided. Consequently, even a person who is not an expert can quickly grasp the state of the sealing surface, and a treatment suitable for the state of the sealing surface can be efficiently performed.

### Other Embodiment

(1) Server 30 may have some of the functional configurations of information processing device 10 in FIG. 13 in the above-described embodiment. For example, information processing device 10 may include image acquisition unit 201 and color difference calculation unit 203, and server 30 may include coincidence calculation unit 205, first determination unit 207, detection unit 209, region determination unit 211, second determination unit 213, and output control unit 215. In this case, information processing device 10 transmits the color difference and the like calculated by color difference calculation unit 203 to server 30.

(2) In the above-described embodiments, it is also possible to provide a program for enabling a computer to execute the control as described in the above-described flowchart. Such a program can also be provided as a program product by being recorded on a non-transitory computer-readable recording medium such as a flexible disk, a compact disk read only memory (CD-ROM), a secondary storage device, a primary storage device, or a memory card attached to the computer. Alternatively, the program can be provided by being recorded on a recording medium such as a hard disk built in the computer. Further, the program can be provided by being downloaded over a network.

The program may be a program that calls a necessary module in a predetermined sequence at a predetermined timing from among program modules provided as a part of an operating system (OS) of the computer to perform processing. In this case, the program itself does not include the modules, and the processing is performed in cooperation with the OS. A program having no such modules may also be included in the program according to the present embodiment. Further, the program according to the present embodiment may be provided by being incorporated into a part of the other program. In this case as well, the program itself does not include modules included in the other program, and the processing is performed in cooperation with the other program. A program incorporated into the other program may also be included in the program according to the present embodiment.

(3) Each of the configurations exemplified as the above-described embodiments is an example of the configuration of the present disclosure, and may be combined with another known technique, or may be modified, for example, partially omitted, without departing from the gist of the present disclosure. Further, in the above-described embodiments, the processing and configuration described in the other embodiment may be employed and implemented as needed.

It should be understood that the embodiments disclosed herein are illustrative in all respects and not restrictive. The scope of the present disclosure is defined by the claims rather than the above description, and the present disclosure is intended to include the claims, equivalents of the claims, and all modifications within the scope.

### REFERENCE SIGNS LIST

10: information processing device, 22: camera, 24: flange, 30: server, 40: terminal device, 61: fastening portion, 101: processor, 103: memory, 105: display, 107: input device, 109: input/output interface, 111: communication interface, 150: user interface screen 201: image acquisition unit, 203: color difference calculation unit, 205: coincidence calculation unit, 207: first determination unit, 209: detection unit, 211: area determination unit, 213: second determination unit, 215: output control unit, 1000: determination system.

What is claimed is:

1. A determination system comprising:
an image acquisition unit that acquires an image of a sealing surface of a target flange;
a color difference calculation unit that calculates a first color difference between a color value of a first image of a first sealing surface to which rust is adhered and a color value of the image of the sealing surface of the target flange and a second color difference between a color value of a second image of a second sealing surface on which an adhesive material does not exist and a color value of the image of the sealing surface of the target flange;
a coincidence calculation unit that calculates first coincidence between the first sealing surface and the sealing surface of the target flange based on the first color difference, and calculates second coincidence between the second sealing surface and the sealing surface of the target flange based on the second color difference; and
a first determination unit that determines an adhesion state of the adhesive material on the sealing surface of the target flange based on the first coincidence and the second coincidence.

2. The determination system according to claim 1, wherein the first determination unit determines that rust adheres to the sealing surface of the target flange regardless of the second coincidence when the first coincidence is greater than or equal to a first threshold.

3. The determination system according to claim 2, wherein the first determination unit determines that the adhesive material does not exist on the sealing surface of the target flange when the first coincidence is less than a second threshold smaller than the first threshold and the second coincidence is greater than or equal to a third threshold.

4. The determination system according to claim 3, wherein the first determination unit determines that the adhesive material other than the rust adheres to the sealing surface of the target flange when the first coincidence is less than the second threshold and the second coincidence is less than the third threshold.

5. The determination system according to claim 1, further comprising:
a detection unit that detects a flaw generated on the sealing surface of the target flange based on the image of the sealing surface;
a region determination unit that determines whether the flaw is included in a first region close to a center of the sealing surface of the target flange or a second region far from the center; and
a second determination unit that determines whether to permit the flaw based on at least one of a thickness, a length, and an angle of the flaw and a region where the flaw exists.

6. The determination system according to claim 5, wherein the second determination unit determines not to permit the flaw when the flaw exists in the first region and the thickness of the flaw is greater than or equal to a reference value, or when the flaw exists in the first region and the angle of the flaw is greater than or equal to a predetermined angle.

7. The determination system according to claim 5, wherein the second determination unit determines not to permit the flaw when the flaw exists in the second region, the thickness of the flaw is greater than or equal to the reference value, and the angle of the flaw is greater than or equal to the predetermined angle.

8. The determination system according to claim 5, wherein the second determination unit determines to permit the flaw when the flaw exists in the second region, the thickness of the flaw is less than the reference value, the angle of the flaw is less than the predetermined angle, and the length of the flaw is less than a predetermined length.

9. The determination system according to claim 5, further comprising an output control unit that outputs advice information regarding the target flange based on at least one of a determination result of the first determination unit and a determination result of the second determination unit.

10. The determination system according to claim 9, wherein the output control unit outputs advice information recommending polishing of the sealing surface of the target flange based on the determination result of the first determination unit that rust is adhered to the sealing surface of the target flange or the determination result of the second determination unit that the detected flaw is not permitted.
